(19) United States
(12) Patent Application Publication
(10) Pub. No.: US 2013/0198103 A1
(43) Pub. Date: Aug. 1, 2013

(54) Mapping Between Different Delta Handling Patterns

(71) Applicants: Marcus Echter, Walldorf (DE); Knut Heusermann, Bad Schoenborn (DE); Albert Neumueller, Walldorf (DE); Matthias Becker, Bruchsal (DE); Oliver Berger, Walldorf (DE); Christian Hohmann, Walldorf (DE); Guang Yang, Bad Schoenborn (DE); Olga Kreindlina, Heidelberg (DE); Dietmar Henkes, Schwetzingen (DE); Torsten Buecheler, Speyer (DE); Martin Haerterich, Wiesloch (DE); Sophie Kraut, Walldorf (DE); Xenia Rieger, Walldorf (DE); Walter Zimmermann, Walldorf (DE)

(72) Inventors: Marcus Echter, Walldorf (DE); Knut Heusermann, Bad Schoenborn (DE); Albert Neumueller, Walldorf (DE); Matthias Becker, Bruchsal (DE); Oliver Berger, Walldorf (DE); Christian Hohmann, Walldorf (DE); Guang Yang, Bad Schoenborn (DE); Olga Kreindlina, Heidelberg (DE); Dietmar Henkes, Schwetzingen (DE); Torsten Buecheler, Speyer (DE); Martin Haerterich, Wiesloch (DE); Sophie Kraut, Walldorf (DE); Xenia Rieger, Walldorf (DE); Walter Zimmermann, Walldorf (DE)

(73) Assignee: SAP AG, Walldorf (DE)

(21) Appl. No.: 13/363,032

(22) Filed: Jan. 31, 2012

(51) Int. Cl. G06Q 10/00

(52) U.S. Cl. 705/342

(57) ABSTRACT

A received delta message of a first kind, expressed in one interchange format, may be used to modify business record(s) in accordance with the processing of a delta message of a second kind expressed in a different interchange format. Conversely, a delta message of the first kind may be generated to express modifications made to a business record, where the modifications are specified in accordance with a delta message of the second kind.

### BACKGROUND

Unless otherwise indicated herein, the approaches described in this section are not prior art to the claims in this application and are not admitted to be prior art by inclusion in this section.

An enterprise may incorporate several business systems to run its operations. Business systems may have business records that correspond, but are not identical, to each other. Various formats for communicating changes (“deltas”) of a business record in one business system with corresponding business record(s) in another business system have arisen. For example, Intermediate Documents is an interchange format that some business systems use, such as SAP® Enterprise Resource Planning (ERP). Another interchange format is called SAP® Enterprise Service Definition (ESD), which is a web services based format used by later developed business platforms such as SAP® Business ByDesign®.

Integration of business systems in an enterprise often involve incompatible business systems exchanging data that is common between such systems. A challenging area is the processing of different interchange formats to facilitate integrating different business systems such as SAP® ERP and SAP® Business ByDesign®.

### BRIEF DESCRIPTION OF THE DRAWINGS

FIG. 1 is a high level illustration of the exchange of information between business systems in accordance with principles of the present disclosure.

FIG. 2 illustrates mapping of data elements and data fields between business records.

FIG. 3 illustrates the use of a mapping table to facilitate the processing of an incoming delta message.

FIG. 4 illustrates the use of a mapping table to facilitate generating an outgoing delta message.

FIG. 5 illustrates a representation of a business record.

FIG. 6 is a flow chart showing the processing of an incoming delta message.

FIGS. 7-10 are illustrative examples of changes between business records and their relation to a delta message.

FIG. 11 is a flow chart showing the generating of an outgoing delta message.

FIG. 12 is an example of a computer system in accordance with the present disclosure.

FIGS. 13A-13C show examples of SAP® ESD formatted delta messages.

### DETAILED DESCRIPTION

In the following description, for purposes of explanation, numerous examples and specific details are set forth in order to provide a thorough understanding of the present disclosure. It will be evident, however, to one skilled in the art that the present disclosure as defined by the claims may include some or all of the features in these examples alone or in combination with other features described below, and may further include modifications and equivalents of the features and concepts described herein.

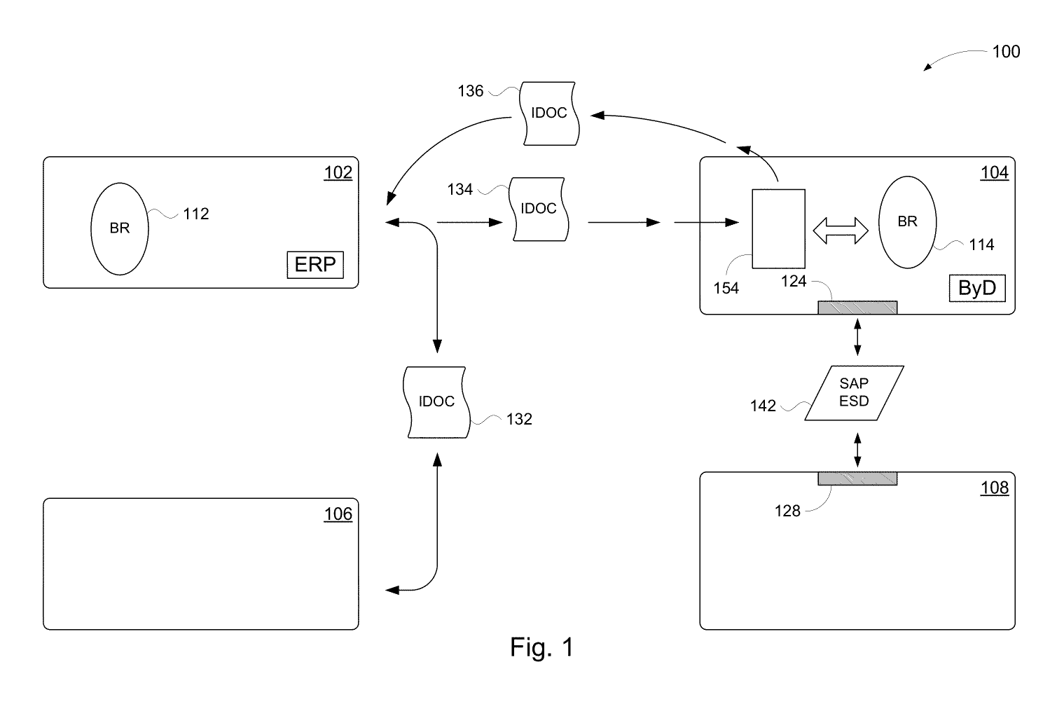

Referring to FIG. 1, a configuration for handling delta messages in a business enterprise 100 in accordance with embodiments of the present disclosure may include business systems 102, 104, 106, and 108. Business systems 102 and 104 may create and maintain respective business records 112 and 114 in the course of operating the business enterprise 100. The term “business record” may encompass any amount and structure of data that is suitable for the business system. For example, a corporate account with all its contact people and contact information of the business may be represented by a business record called “account.” As another example, the component parts of a machine may be represented in a single business record.

It is typical that the business systems in an enterprise may exchange data, such as customer data, inventory data, supplier data, and so on, with other systems. The exchange of data may be triggered for any of several reasons. For example, when the business record 112 is changed (e.g., customer information is updated, sales order is changed, etc.), corresponding data in another business system may need to be updated; the “update” process is sometimes referred to as “synchronizing” data between two systems. Thus, business system 102 may synchronize (“synch”) data with a business system 106, and vice versa; likewise, business system 104 may synch data with a business system 108, and so on.

Different messaging formats for the interchange of data between business systems have been developed. For example, business system 102 may communicate its changes to business system 106 in a message 132 using a format referred to a Intermediate Documents (IDOCs). Merely as an example, SAP® ERP is an enterprise resource planning (ERP) system that uses IDOCs. Business system 104 may communicate its changes to business system 108 in messages based on web services. For example, SAP® Business ByDesign® is a business platform that uses a web service format called SAP® Enterprise Service Definition (ESD). Messages may represent the entire business record or only portions of a business record. A message may include only those data fields in the represented business record that were changed; this configuration is referred to as a “delta transmission”; i.e., only the deltas (changes) made to the business record are transmitted. Alternatively, a message may include all data fields of the represented business record including changed data fields and unchanged data fields; this configuration is referred to as a “full transmission”; i.e., all the fields in the represented business record are transmitted.

In accordance with the present disclosure, the business system 102 may exchange data with business system 104 in the same manner as with business system 106, namely via a message 134 that is formatted in accordance with the interchange format understood by business system 102 (e.g., IDOCs). In this usage case, the business system 102 may be an earlier legacy system that communicates with a newer business system 104. In some embodiments, therefore, the business system 104 may include a handler 154 that receives a message 134 from business system 102 (“sending” business system) that is formatted in accordance with an interchange format that the sending business system understands. The handler 154 may update one or more elements of the business record 114 according to contents of the message 134. Conversely, in some embodiments, the handler 154 may generate a message 136 from data contained in business record 114 that is formatted in accordance with the interchange format understood by business system 102.

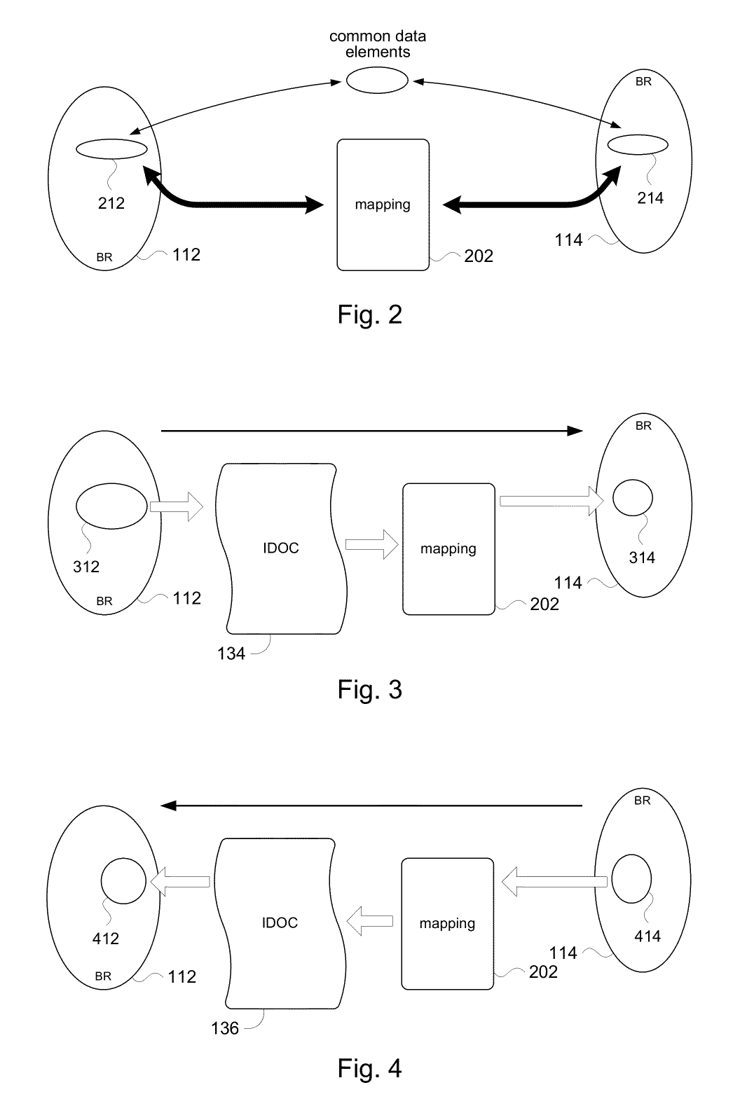

Referring to FIG. 2, a business record 112 in the business system 102 may have a corresponding business record 114 in business system 104. However, since the business systems 102 and 104 are different systems, the structure and data content of business record 112 may not be the same as the structure and data content of business record 114. Data elements that are common to both business record 112 and business record 114 may be stored in the former differently from the latter. For example, a customer name may be stored in a data field called “CustName” in business record 112, while in business record 114 the data field might be called “Name-of-Customer”. As another example, a customer address may be stored in two data fields called “StreetNumber” and “StreetName” in the business record 112, while in business record 114 the same information may be stored in a single data field called “Street Address.” Accordingly, a mapping table 202 may be used to manage the mapping of common data elements between business records 112 in business system 102 and business records 114 in business system 104.

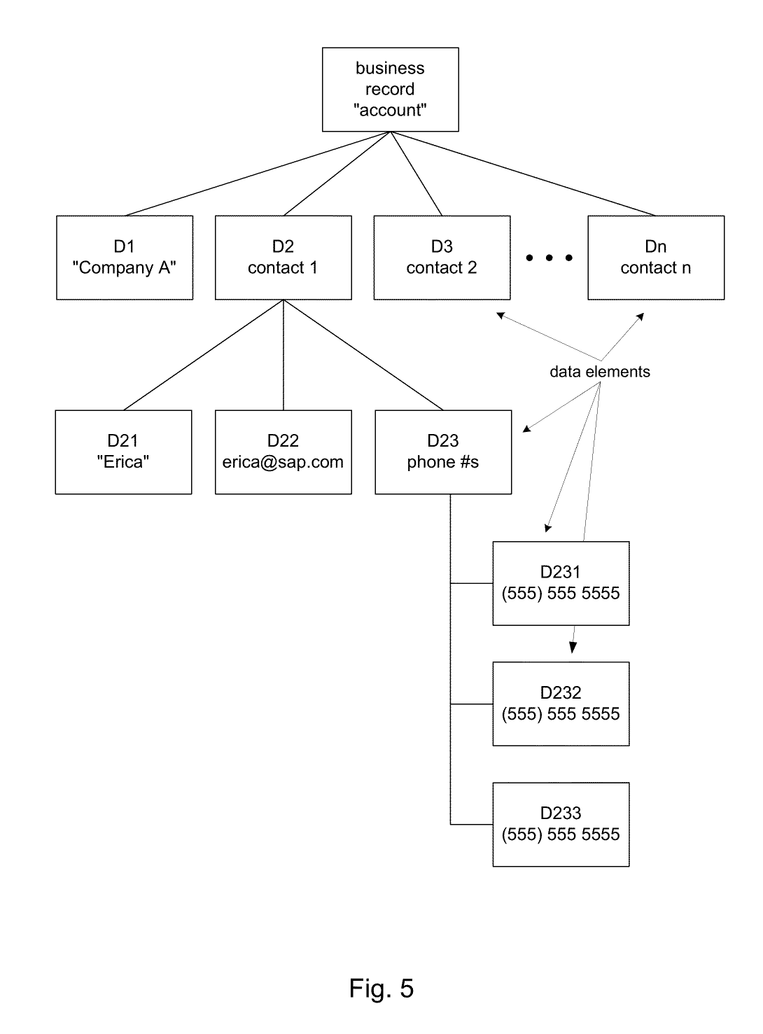

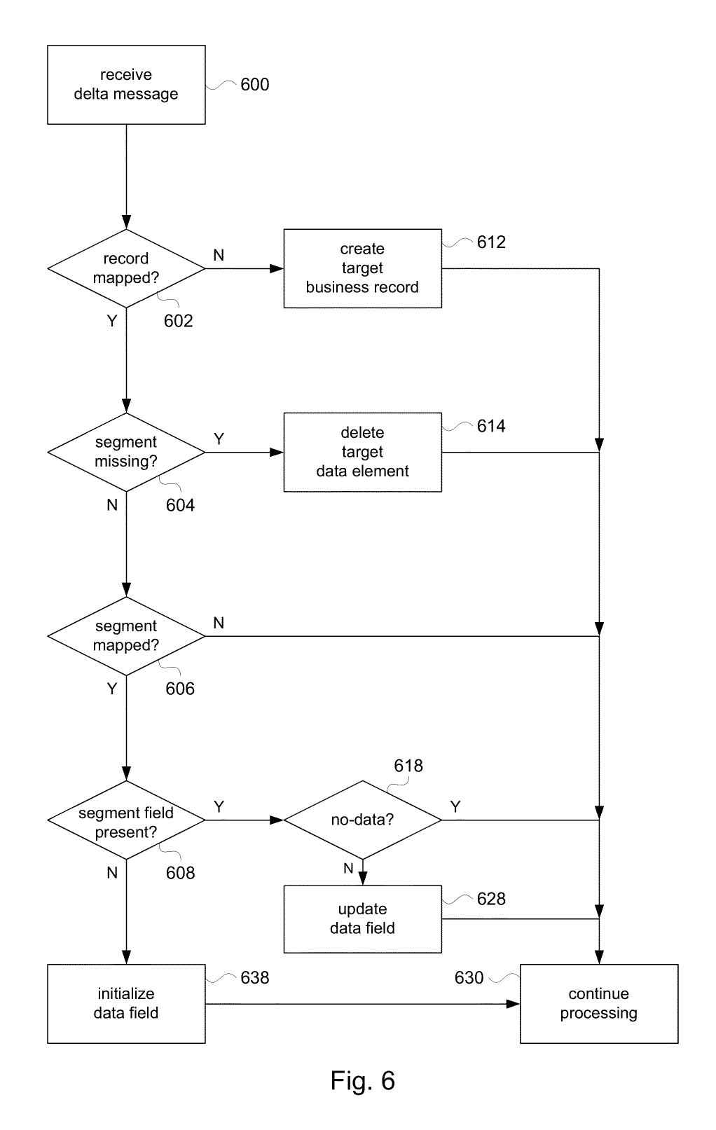

Referring to FIG. 3, changes made to data elements 312 of business record 112 in business system 102 may be represented in a message 134. As will be explained below, the mapping table 202 may be used to incorporate some of the data elements 312 from business record 112 that are represented in the message 134 into corresponding data elements 314 of business record 114. Similarly, with reference to FIG. 4, changes made to data elements 414 in business record 114 may be represented in a message 136. As will be explained below, the mapping table 202 may be used to represent some of the data elements 414 of business record 114 into message 136. The business system 102 may then update corresponding data elements 412 its business record 112 when it reads in message 136.

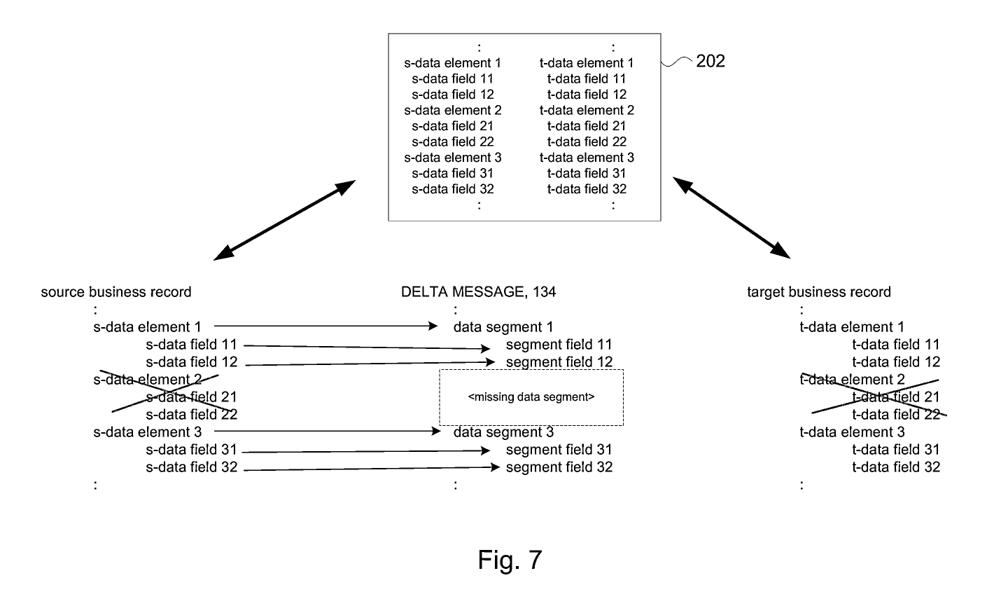

Without losing generality, a business record may be described as a collection of data that is organized in some structure of “data elements.” A data element may be deeply structured, comprising one or more data fields, one or more data elements, a combination of data fields and data elements, and so on. FIG. 5 is an illustrative representation of a business record, using a tree structure to represent a business record. It will be appreciated, of course, that other representations are equally valid. The business record itself may be viewed as being the root node of the tree. The data elements may be children nodes. For example, as shown in the figure, the business record may represent a customer account. The data element D1 may be a data field node that stores the customer name, for example, “Company A.” The data elements D2-Dn may be date element nodes, where each node represents a contact person in that account. Each data element node D2-Dn may in turn comprise additional data elements. For example, data element D2 may include a data field node D21 that contains the contact's name, a data field node D22 that contains an email address, and a data element node D23 of phone numbers. The data element node D23 may contain list of data field nodes D231-D233, each storing a telephone number. Business records 112 in business system 102 may be represented in the manner illustrated in FIG. 5. Likewise, business records 114 in business system 104 may be represent as shown in FIG. 5.

The format of a message 134 (e.g., FIG. 3) that is used to represent changes in a business record (e.g., business record 112) will now be described. In some embodiments, the content of message 134 may be structured as shown in TABLE I below:

TABLE I
delta message (DELTA transmission type)

```
<op code> <ID>
<op code> data segment 1
      <op code> data segment 11
      <op code> data segment 12
      :
<op code> data segment 2
      <op code> data segment 21
            <op code> data segment 211
            <op code> data segment 212
      <op code> data segment 22
            <op code> data segment 221
            <op code> data segment 222
    :
<op code> data segment 3
      :
<op code> data segment n
```

The message 134 may include an “ID” field which identifies the business record. The message 134 comprises data segments that represent the data elements of the business record. Without loss of generality, the data segments in message 134 may have the same structure as the business record it represents, and so the structure of the data segments in message 134 may be described by the tree structure representation depicted in FIG. 5. A data segment may therefore comprise one or more “segment fields” which represent data fields data fields of the business record, one or more data segments, a combination of segment fields and data segments, and so on. The message 134 represents all or part of the business record; the phrase “represented business record” will be understood as referring to all or part of the business record.

If the message 134 contains only those data elements of the represented business record 112 that have been modified, the message is referred to as a “delta transmission”. If the message 134 contains all of the data elements of the represented business record 112, the message is referred to as a “full transmission.” In either case, the message 134 itself may be referred to as a “delta message” because its purpose is to convey changes (“deltas”) in a represented business record, whether by full transmission or by delta transmission. Whether a delta message 134 is transmitted as a full transmission or a delta transmission may depend on the nature of the business record and on the particular business application running on the business system (e.g., business system 102) that prepares and sends the delta message. For example, some legacy business applications may only provide full transmission delta messages.

The delta message 134 depicted in TABLE I represents a delta transmission type delta message. Accordingly, data segments represent only those data elements in the represented business record 112 that are modified. Moreover, each data segment is associate with an operation code (“op code”) to indicate what kind of change was made to its associated data segment. For example, in an IDOCs formatted message, the operation code is referred to as a MSGFN code. In some embodiments, the operation codes that are handled may include: REPLACE, CHANGE, CREATE, UNCHANGED, and DELETE. Processing for each operation code will be discuss in more detail below.

The delta message 134 depicted in TABLE II below represents an example of a full transmission type delta message. The data segments in a full transmission delta message represent all of the data elements of the represented business record 112. There is only one operation code that is associated with the represented business record 112.

TABLE II
delta message (FULL transmission type)

```
<ID> <op code>
data segment 1
      data segment 11
      data segment 12
      :
data segment 2
      data segment 21
            data segment 211
            data segment 212
      data segment 22
            data segment 221
            data segment 222
    :
data segment 3
      :
data segment n
```

Still a third form of delta message is possible, and an example is illustrated in Table III below. This form of delta message is a full transmission delta message without delta handling capability. The message is similar to the type shown in TABLE II, but does not include an operation code. Some applications running on business system 102 may use this format of delta messages; for example a legacy application may only support this form of delta message.

TABLE III
delta message (FULL transmission, no delta handling)

```
<ID>
data segment 1
      data segment 11
      data segment 12
      :
data segment 2
      data segment 21
            data segment 211
            data segment 212
      data segment 22
            data segment 221
            data segment 222
    :
data segment 3
      :
data segment n
```

The discussion will now turn to processing of a received delta message in accordance with principles of the present disclosure. In some embodiments, business system 104 may include handler 154 (FIG. 1) configured to receive a delta message from a sending computer system (e.g., business system 102). For example, if a change is made to business record 112 in business system 102, then the business system may send delta message 134 to business system 104 so that the latter can synchronize its business record 114 with the changes. Since business system 104 uses an interchange format that is different from the interchange format used by business system 102, the handler 154 processes the delta message 134 in accordance with the delta handling performed by the receiving business system (i.e., business system 104). The handler 154 may process a received delta message 134 according to the one or more operation codes contained in the delta message.

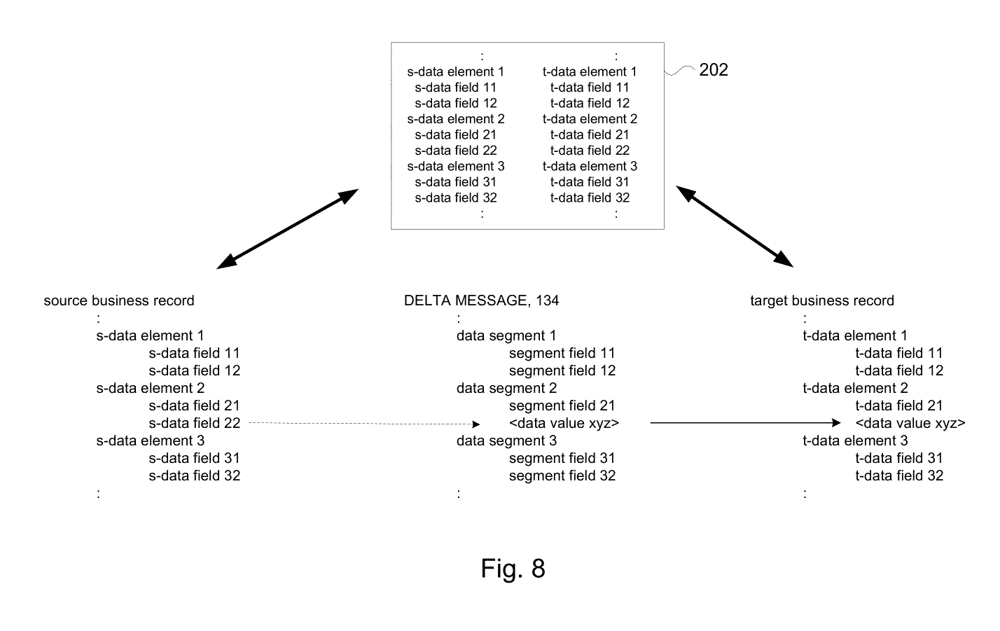

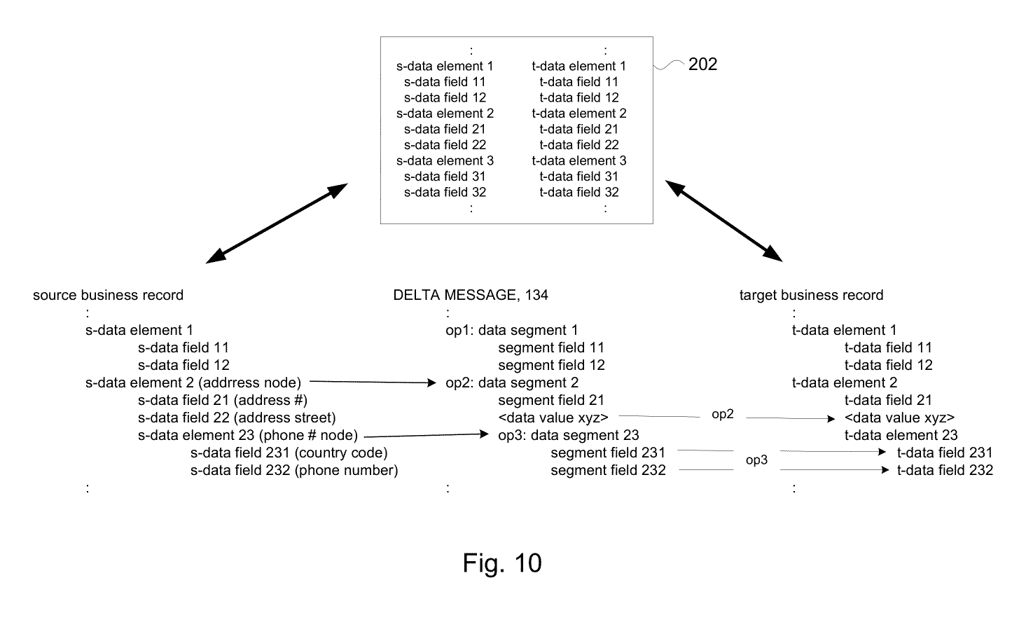

Consider, merely as an example, that business system 102 is an SAP® ERP system and business system 104 is an SAP® Business ByDesign® business platform. Suppose that a change is made in a business record 112 in the SAP® ERP system 102. Suppose further that the modified business record 112 is synchronized with a corresponding business record 114 in the SAP® Business ByDesign® business platform 104. The delta message 134 generated by the SAP® ERP system may be formatted according to the IDOCs format. On the other hand, the SAP® Business ByDesign® business platform 104 processes delta messages in the SAP® ESD format. Accordingly, handler 154 in the SAP® Business ByDesign business platform 104 may process a delta message 134 received from the SAP® ERP system 102 by mapping the IDOCs parameters in the received delta message into corresponding operations of an SAP® ESD delta message according the processing shown in FIGS. 6-10. Thus, changes made to a target business record in the SAP® Business ByDesign® business platform 104 are effected by SAP® ESD delta processing and directed by an IDOCs delta message received from the SAP® ERP system 102.

Referring then to FIG. 6, a description for processing a delta message of the type shown in TABLE II, namely a full transmission with delta handling, will be discussed. In an embodiment, a full transmission delta message with delta handling may have an operation code of REPLACE. For example, the processing in FIG. 6 may be used to process an IDOC full transmission delta message having MSGFN=005; see below for an explanation of the IDOC message format. The handler 154 in the business system 104 (“receiving business system”, e.g., SAP® Business ByDesign® business platform) may receive an IDOC delta message 134 (at step 600) and map the operations to corresponding operations in the receiving business system to process the received delta message in accordance with the flow shown in FIG. 6.

At step 602, a determination is made whether the business record (the “source business record”) identified in the delta message 134 maps to one or more “target business records” in the receiving business system 104. For example, the business system 104 may maintain a mapping table 202 which can be used to make this determination. It is noted that a business record 112 in business system 102 may map to one or more business records in business system 104. It will be understood that the phrase “target business record” mentioned in the following flow charts and description may refer to one or more target business records.

Continuing with FIG. 6, if at step 602 the source business record does not map to a target business record, then at step 612 one or more target business records are created (instantiated) which correspond (“map”) to the source business record. Processing then continues at step 630; for example, the data elements of the newly created target business records may be initialized.

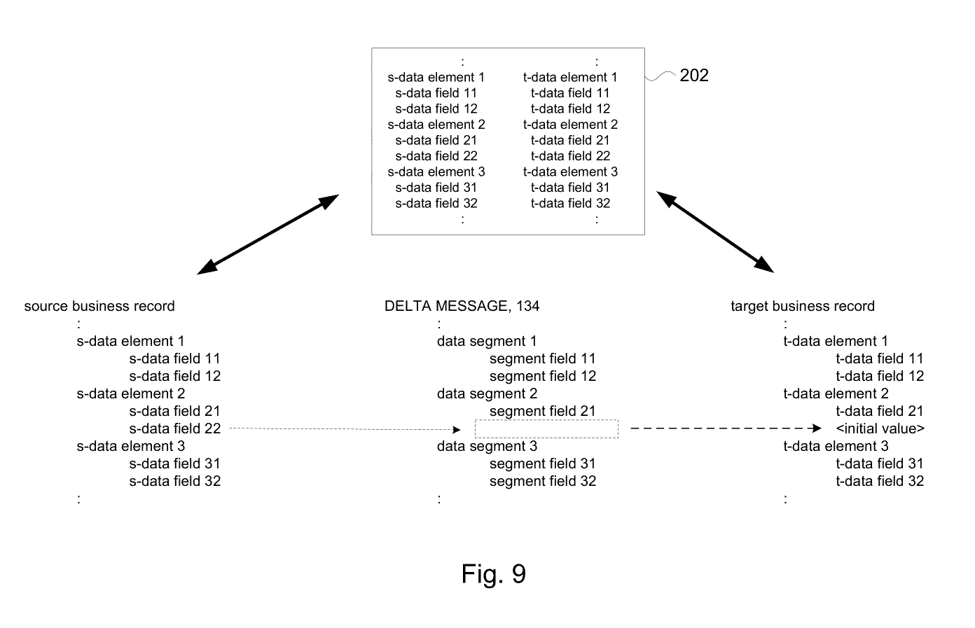

If the source business record does map to a target business record, then the data elements of the mapped target business record may be modified according to the following. In step 604, if a data element in the target business record (“target data element”) maps to a corresponding data element in the source business record (“source data element”), and if that source data element is NOT represented in the delta message 134 by a data segment (i.e., the whole data segment is missing), then that target data element is deleted from the target business record at step 614. Processing then continues as indicated by the flow to step 630. For example, step 604 may be repeated with other data elements of the target business record to determine if they need to be deleted. FIG. 7 illustrates this situation with an example where a source business record and a target business record are mapped by a mapping table 202. The delta message 134 shown in the figure may be generated as the result of deleting “s-data element 2” (e.g., this data element may be a client contact that got deleted from the source business record) Since “t-data element 2” maps to “s-data element 2” (per mapping table 202, for example), then the delta message 134 would be expected to contain “data segment 2.” However, “data segment 2” is missing from the delta message 134, and so in some embodiments, “t-data element 2” would be deleted from the target business record.

Returning to FIG. 6, if in step 606 a data segment in the delta message does not represent a source data element that maps to a data element in the target business record, then the data in that data segment does not correspond to any data fields in the target business object and thus may simply be ignored (e.g., do not update any data fields in the target business record). Processing may continue at step 630; for example, to evaluate other data segments in the delta message.

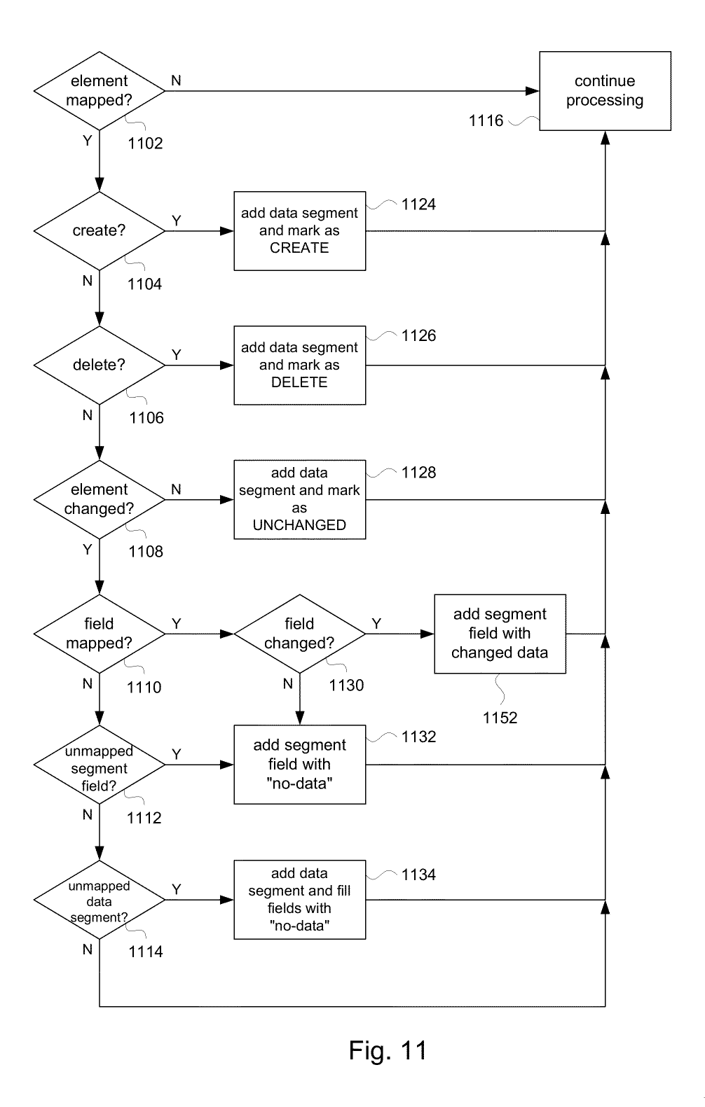

In step 608, if a data segment in the delta message does represent a source data element that maps to a data element in the target business record, then data fields comprising the target data element (if any) may be modified. In particular, if the data segment in the delta message 134 contains a segment field that maps to a data field in the target business record (i.e., the segment field represents a data field in the source business record that maps to a data field in the target business record), then in step 618 if the data contained in that segment field is a “no-data” operator (e.g., “/”), then the value in the data field in the target business record remains unchanged. Otherwise, the data field in the target business record may be updated in step 628 using the data contained in that segment field. FIG. 9 illustrates this situation with an example, where “t-data field 22” maps to “s-data field 22” per the mapping table 202. The delta message 134 includes a data segment (“data segment 2” that represents “s-data element 2.” Since “data segment 2” includes a segment field (having a value “data value xyz”) that represents “s-data field 22,” the “t-data field 22” in the target business record would therefore be updated with “data value xyz.”

Returning to step 608 in FIG. 6, if there is a mapping between a data field in the target data element and a data field in the source business record, and there is no segment field that represents the data field in the source business record, then in step 638, the data field in the target data element may be initialized to an initial data state. FIG. 9 illustrates this situation with an example, where “t-data field 22” maps to “s-data field 22” per the mapping table 202. The delta message 134 includes a data segment (“data segment 2” that represents “s-data element 2.” However, “data segment 2” does not include a segment field that represents “s-data field 22.” In some embodiments, the “t-data field 22” in the target business record would therefore be initialized.

The discussion will now consider the processing by the handler 154 (FIG. 1) of a received delta message 134 of the type illustrated in TABLE I above, namely a delta transmission. Each data segment in the received delta message 134 is associated with an operation code. For example, a data segment that is associated with an operation code of DELETE (e.g., an IDOCs delta message having a data segment associated with a MSGFN=003) causes the corresponding data element in the target business record to be deleted from the target business record; i.e., the data element in the target business record which maps to a data element in the source business record that is represented by the data segment. Processing then continues with remaining data segments in the received delta message 134.

A data segment in the delta message 134 that is associated with an operation code of CREATE (e.g., an IDOCs delta message having a data segment associated with a MSGFN=009) may create data fields in the target business record. For example, if the data segment includes a segment field which maps to the target business record, then a data field in the target business record is instantiated. If a data field in the target business record has a mapping to the source business record but is not represented by a segment field, then the data field in the target business record is set to an initial data state. Processing then continues with remaining data segments in the received delta message 134.

A data segment in the delta message 134 that is associated with an operation code of CHANGE (e.g., an IDOCs delta message having a data segment associated with a MSGFN=004 or MSGFN=005) may modify data fields in the target business record. For example, if the data segment includes a segment field which represents a data field in the source business record that has a mapping to the target business record, then the data field in the target business record is updated according to the segment field. If a data field in the target business record has a mapping to the source business record but is not represented with a segment field, then the data field in the target business record is set to an initial data state. In some embodiments, an operation code of REPLACE is processed in the same manner. Processing then continues with remaining data segments in the received delta message 134.

A data segment in the delta message 134 that is associated with an operation code of UNCHANGED (e.g., an IDOCs delta message having a data segment associated with a MSGFN=018) may cause one or more data fields in a target business record to be created (instantiated). For example, suppose a data segment in the delta message represents a data field in the source business record that has a mapping to a data field in the target business record. However, if no such data field in the target business record is currently instantiated, then in some embodiments the data field may be instantiated in the target business record. Otherwise, if target business record already exists, then it remains unchanged. Processing then continues with remaining data segments in the received delta message 134.

The discussion will now consider the processing of a delta message of the type illustrated in TABLE III above, namely a full transmission without delta handling. As explained, a full transmission contains all of the data segments of the represented portion of business record 112, including modified and unmodified data segments. The “without delta handling” refers to the absence of an operation code from the delta message. In some embodiments, a full transmission delta message without delta handling may be processed by the handler 154 (FIG. 1) in accordance with the processing of FIG. 6 for full transmission delta messages with delta handling, where the operation code is REPLACE.

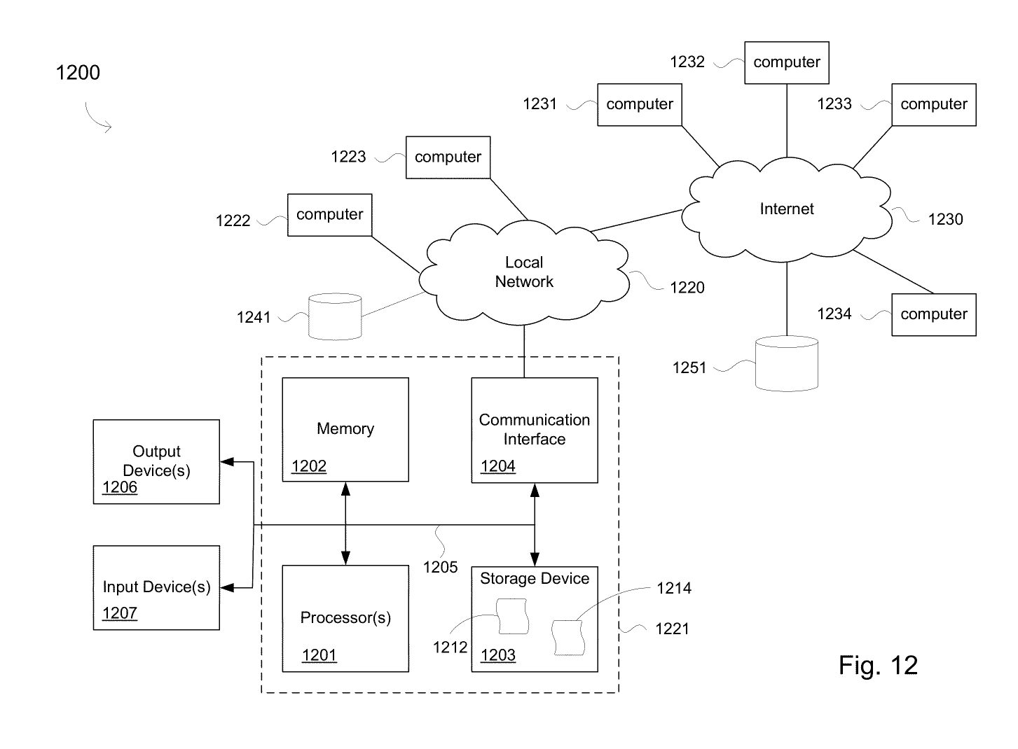

In some embodiments, the operation code associated with a data segment in a delta message applies to constituent data segments that are segment fields. Referring to FIG. 10, suppose “data segment 2” represents an “address” node in the source business record and that the address node includes a “phone #” node. The operation code “op2” in the delta message associated with “data segment 2” applies only to address fields “address #” and “address street”. Accordingly, the corresponding data field in the target business record is updated in accordance with “op2.” The data element “phone #” is not affected by “op2” because “phone #” is not a data field, but rather a nested structured node (“sub-node”) comprising its own data elements (in this case two data fields). Thus, “data segment 23” in the delta message 134 is associated with its own operation code, namely “op3”. If there is data in the segment fields under “data segment 23,” that data would be used to modify the target business record according to the operation code “op3.” It can be appreciated that a deeply structured business record may comprise any combination of such nested data fields and data elements which may be processed in accordance with the present disclosure as explained in connection with FIG. 10.

The discussion will now turn to generating an outbound delta message (e.g., 136, FIG. 1) when a business record in the business system 104 has been modified. The business system 104 (“sending business system”) may send the delta message to the business system 102 (“receiving business system”). The delta message 136 may then be read in by the business application 102 and processed to update its corresponding business records 112.

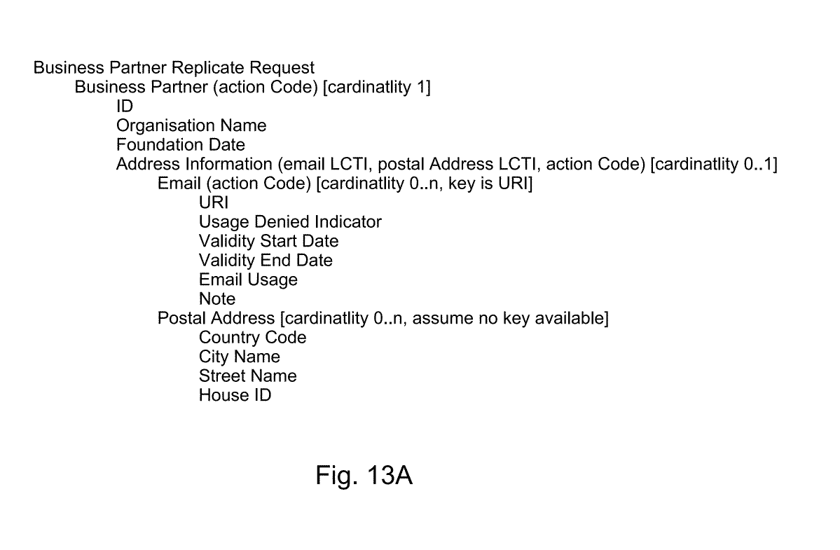

In accordance with the present disclosure, when a business record 114 in business system 104 is modified, and that change is to be sent to business system 102, the handler 154 may process the business record in accordance with FIG. 11. Consider, merely as an example, that business system 102 is an SAP® ERP system and business system 104 is an SAP® Business ByDesign® business platform. Suppose that a change is made in a business record 114 in the SAP® Business ByDesign® business platform 104, and that the modified business record is to synchronized with a corresponding business record 112 in the SAP® ERP system 102. However, the SAP® Business ByDesign® business platform 104 processes delta messages in the SAP® ESD format and the SAP® ERP system 102 processes delta messages in the IDOCs format. Consequently, the handler 154 may process the business record 114 in accordance with FIG. 11 to generate a delta message 136 according to the IDOCs format.

First, it is noted that some (source) data elements in the (source) business record 114 may not have corresponding (target) data elements in the (target) business record 112. Thus, in a step 1102, if a source data element in the source business record 114 does not map to any target data element in a target business record 112 in business system 102, then the source data element is not included in the delta message 136, and processing proceeds continues at 1116. For example, to process data elements in the source business record 114. If on the other hand, the source data element does map to a target data element, then processing proceeds to step 1104.

If in step 1104, the modification to the source business record was the creation of source data element, then in step 1124 a data segment is added to the delta message 136 and associated with an operational code (e.g., MSGFN) of CREATE. Processing may then continue at 1116; e.g., for example, additional data elements in the source business record 114 may be processed.

If in step 1106, the modification to the source business record was the deletion of the source data element, then in step 1126 a data segment is added to the delta message 136 and associated with an operational code of DELETE. Processing may then continue at 1116; e.g., for example, additional data elements in the source business record 114 may be processed.

If in a step 1108, the source data element was not modified, then a data segment is added to the delta message 136 and associated with an operation code of UNCHANGED. Processing may then continue at 1116; e.g., for example, additional data elements in the source business record 114 may be processed.

The “Y” branch from step 1108 indicates that the source data element has been modified. Thus in a step 1110, if a data field in the source data element is mapped to a data field in the target business record (e.g., business record 112), then in a step 1130 a determination is made whether that data field was modified. If so, then in a step 1152, a corresponding segment field is added to the delta message 136 with the modified data. The segment field represents the data field in the target business record to which the data field in the source data element is mapped. Processing may then continue at 1116; e.g., for example, additional data elements in the source business record 114 may be processed. Otherwise, processing from the “N” branch of step 1130 proceeds to a step 1132, where a corresponding segment field is added to the delta message 136 with a “no-data” operator (e.g., “I”) to indicate that the value of the particular data field is not changed. Processing may then continue at 1116 to process the remainder of the source business record.

If in a step 1112, there is a data field in the target business record (e.g., business record 112) that is not mapped to any business records in the source business system (e.g., business system 104), then in some embodiments, a representative segment field may nonetheless be provided in the delta message 136. Accordingly, the step 1132 may performed to fill the segment field with a “no-data” operator. Processing may then continue at 1116 to process the remainder of the source business record.

If in a step 1114, there is data element in the target business record (e.g., business record 112) that is not mapped to any business records in the source business system (e.g., business system 104), then in some embodiments, a representative data segment may nonetheless provided in the delta message 136. Accordingly, in a step 1134 a data segment may be added to the delta message 136 and its constituent segment fields filled with “no-data” operators in order to avoid modifying the data values in the corresponding data element of the target business record. Processing may then continue at 1116 to process the remainder of the source business record.

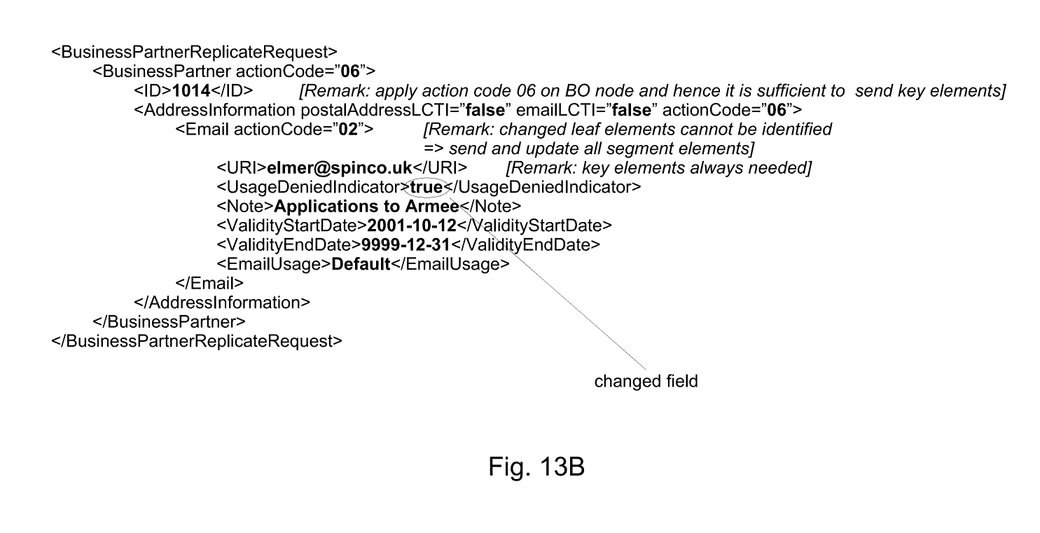

FIG. 12 is a block diagram of a system 1200 according to some embodiments. The system 1200 includes computers 1221-1223 and one or more storage systems 1241 interconnected by a local network 1220 such as a Local Area Network (LAN), a Wide Area Network (WAN), and the like. In some embodiments, the system 1200 may include computers 1231-1234 and one or more storage systems 1251 connected to the Internet 1230. The local network 1220 may be connected to the Internet 1230.

Each computer (e.g., computer 1221) may be configured as a general purpose computing apparatus and may execute program code to perform any of the functions described herein. For example, business system 102 (FIG. 1) may comprise computer 1221, business system 104 may comprise computer 1222.

Each computer (e.g., computer 1221) includes, among its components, a processor component 1201 (comprising one or more processing units) operatively coupled to a communication interface 1204, a data storage device 1203, one or more input devices 1207, one or more output devices 1206, and a memory 1202. The communication interface 1204 may facilitate communication on the local network to access other systems, such as computer 1222 in business system 104 for example.

Input device(s) 1207 may include, for example, a keyboard, a keypad, a mouse or other pointing device, a microphone, knob or a switch, an Infra-Red (IR) port, a docking station, a touch screen, and so on. Input device(s) 1207 may be used, for example, to enter information into the computer. Output device(s) 1206 may include, for example, a display (e.g., a display screen), a speaker, a printer, and so on. Additional elements (not shown) may be including according to some embodiments.

The data storage device 1203 may comprise any appropriate persistent storage device, including combinations of magnetic storage devices (e.g., magnetic tape, hard disk drives and flash memory), optical storage devices, Read Only Memory (ROM) devices, etc., while memory 1202 may comprise Random Access Memory (RAM).

The data storage device 1203 may store program code 1212 which may be executed by the processor component 1201 to cause the computer to perform any one or more of the processes and methods described herein. In embodiments, for example, the program code 1212 in computer 1221 may be a business application executing in business system 102. Likewise, program code in computer 1222 may be a business application executing in business system 104. Embodiments are not limited to execution of these processes by a single apparatus.

The data storage device 1203 may store data structures 1214 such as object instance data, runtime objects, and any other data described herein. The data storage device 1203 may also store data and other program code for providing additional functionality and/or which are necessary for operation thereof, such as device drivers, operating system files, etc.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. It will be appreciated that embodiments are not limited to any specific combination of hardware and software. Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

### Illustrative Embodiments of Delta Messages

As mentioned above, in an illustrative embodiment the business system 102 may be an SAP® ERP business system and the business system 104 may be the SAP® Business ByDesign® business platform. The SAP® ERP business system implements delta handling based on the IDOCs format. The parameters of an IDOCs formatted delta message include a MSGFN parameter, which specifies the nature of the changes to a business record represented by the delta message. For example, in a full transmission message, the MSGFN parameter may be set to “005” that applies to the entire message. In a delta transmission delta message, any of a number of MSGFN codes may be associated with each data segment of the message. MSGFN codes include “003” for a DELETE operation, “004” for a CHANGE operation, “005” for a REPLACE operation, “009” for a DELETE operation, and “018” for an UNCHANGED operation. In addition to MSGFN, an IDOCs delta message may include a no-data operator, namely “/”.

The parameters in an SAP® ESD formatted delta message include an action code, a list complete transmission indicator (TRUE/FALSE), and an element controller. An action code may be associated with each data segment in the delta message and specify an action to be performed on the associated data segment. The action codes include 01 (CREATE), 02 (CHANGE), 03 (DELETE), 04 (SAVE), 05 (REMOVE), and 06 (NO ACTION).

The list completer transmission indicator (LCTI) indicates whether a list of similar child elements is being transmitted in the delta message. If LCTI is TRUE, all corresponding child elements in the list are transmitted. Child elements that are not transmitted in the delta message are implicitly regarded as deleted at the sender. If LCTI is FALSE, corresponding child elements in the list that are not transmitted are regarded as unchanged.

Delta messages in the SAP® ESD format are expressed in Extended Markup Language (XML). The “element controller” aspect of the delta message provides extended XML handling for interface operations for passing additional element information between the delta message and a proxy. For outbound messages, the element controller may:
indicate a data state where a field contains an initial value or no value; this data state may map to an IDOCs field that is empty;
indicate a data state where the field does not appear in the message or does appear in the message with XML element attribute “xsi:nil=‘true’”; this data state may map to an IDOCs field having the NO-DATA operator.

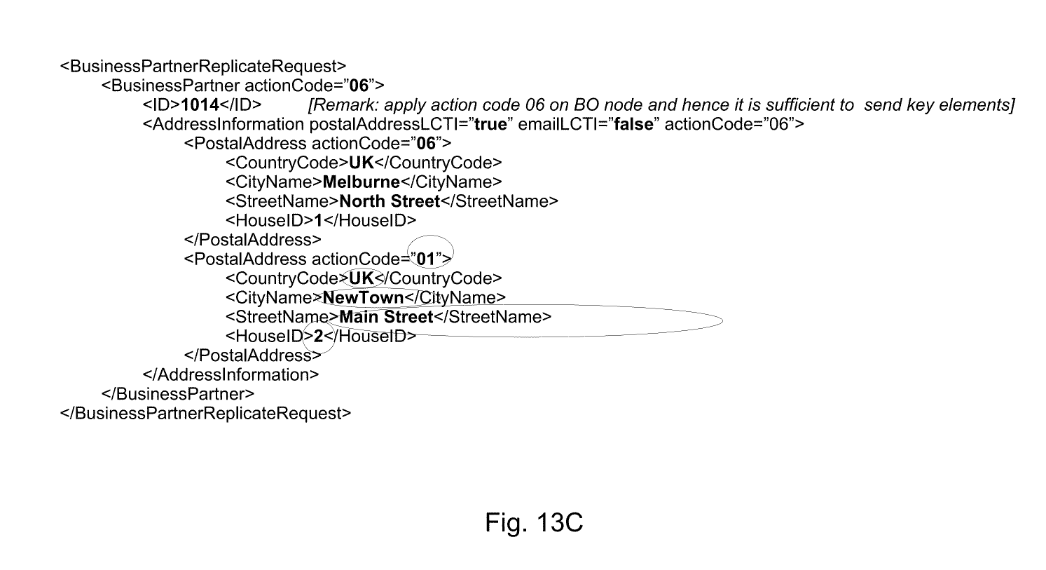

Examples of SAP® ESD formatted delta messages are shown in FIGS. 13A-13C. FIG. 13A shows the basic message structure for a business record. FIG. 13B illustrates an example of a delta message where the email usage indicator for the email address:
elmer@spinco.uk
   has been changed to “true”, as indicated in the figure, showing in bold characters changed and unchanged fields. The changed field is shown circled. FIG. 13C illustrates an example of another delta message in which a new postal address has been added to the business partner, showing in bold characters changed and unchanged fields. Changed fields are circled.

In embodiments, an IDOCs delta message received by the SAP® Business ByDesign® business platform 104 may be processed by mapping the IDOCs message pattern to operations corresponding to SAP® ESD message patterns. Similarly, embodiments may generate an IDOCs formatted delta message in the SAP® Business ByDesign® business platform 104 by mapping the SAP® ESD message pattern to operations corresponding to IDOCs message patterns.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the disclosure as defined by the claims.

What is claimed is:

1. A method, in a receiving computer system, of processing a business record in accordance with a received delta message comprising operating the receiving computer system to perform steps of:
receiving at the receiving computer system, a delta message of a first format sent from a sending computer system, the delta message comprising at least one operation code, an identification of a source business record in the sending computer system, and a plurality of data segments representing source data elements of the source business record,
wherein the receiving computer system is configured to process delta messages of a second format different from the first format,
wherein the receiving computer system maps operations specified in the delta message of the first format to operations for processing delta messages of the second format, including:
(a) if the source business record does not correspond to any target business records in the receiving computer system, then creating one or more corresponding target business records; and
(b) if the source business record does correspond to one or more target business records in the receiving computer system, then modifying the one or more target business records according to the operation code, including:
if a target data element in the one or more target business records is mapped to a source data element that is not represented by a data segment in the delta message, then deleting the target data element; and
if a target data element in the one or more target business records is mapped to a source data element that is represented by a data segment in the delta message, then:
if a segment field of the data segment represents a data field in the source business record that maps to a data field in the target data element, then updating the data field of the target data element using data associated with the segment field; and
if a data field of the target data element maps to a data field in the source business record that is not represented by a segment field of the data segment, then initializing the data field of the target data element to an initial data state.

2. The method of claim 1 wherein the operation code designates an operation of REPLACE or CHANGE.

3. The method of claim 1 wherein if a data segment is associated with an operation code that designates an operation of UNCHANGED, then if a target data element in the one or more target business records is mapped to a source data element that is not represented by the data segment, then creating an instance of the target data element setting the target data element to an initial data state.

4. The method of claim 1 wherein if a data segment is associated with an operation code that designates an operation of DELETE, then deleting a target data element in the one or more target business records that is mapped to the source data element represented by the data segment.

5. The method of claim 1 wherein data fields of the target business record that do not correspond with any of the data fields of the source business record remain unchanged.

6. The method of claim 1 wherein the first format is the IDOC format, wherein the second format is the SAP® ESD format.

7. The method of claim 1 further comprising receiving a subsequent delta message that is absent an operation code and processing the subsequent delta message according to steps (a) and (b).

8. The method of claim 1 if a segment field of the data segment represents a data field in the source business record that maps to a data field in the target data element and the segment field is associated with a no-data operator, then leaving the data field of the target data element unchanged.

9. The method of claim 1 further comprising the receiving computer system generating an outgoing delta message representing changes made to a changed business record in the receiving computer system, the outgoing delta message being used to update a target business record (“second target business record”) in the sending computer system.

10. The method of claim 9 wherein only if a data element in the changed business record corresponds to a data element in the second target business record, then adding a data segment to the outgoing delta message which represents the data element in the second target business record.

11. The method of claim 10 wherein if the data element in the changed business record has been created or deleted, then associating the added data segment with an operation code designating a corresponding operation of CREATE or DELETE.

12. The method of claim 10 wherein if the data element in the changed business record has not been modified, then associating the added data segment with an operation code designating the operation UNCHANGED.

13. The method of claim 10 wherein if the data element in the changed business record has been changed, then associating one or more segment fields of the added data segment with data from the changed data element.

14. The method of claim 10 wherein if the second target business record includes a data field that does not correspond to a data field in the changed business record, then adding a segment field to the outgoing delta message that represents the data field of the second target business record and filling the segment field with a no-data operator.

15. The method of claim 10 wherein if the second target business record includes a data element that does not correspond to a data element in the changed business record, then adding a data segment to the outgoing delta message that represents the data element of the second target business record and filling the data segment with no-data operators.

16. A receiving computer system comprising:
a computer component; and
a data storage component having stored thereon executable computer program code, the executable computer program code being executable by the computer component to receive a delta message of a first format sent from a sending computer system, the delta message comprising at least one operation code, an identification of a source business record in the sending computer system, and a plurality of data segments representing source data elements of the source business record,
wherein the receiving computer system is configured to process delta messages of a second format different from the first format,
wherein the receiving computer system maps operations specified in the delta message of the first format to operations for processing delta messages of the second format, wherein the executable computer program code is executed by the computer component to:
(a) determine that the source business record does not correspond to any target business records in the receiving computer system, and in response thereto create one or more corresponding target business records; and
(b) determine that the source business record does correspond to one or more target business records in the receiving computer system, and in response thereto modify the one or more target business records according to the operation code, including:
if a target data element in the one or more target business records is mapped to a source data element that is not represented by a data segment in the delta message, then delete the target data element; and
if a target data element in the one or more target business records is mapped to a source data element that is represented by a data segment in the delta message, then:
if a segment field of the data segment represents a data field in the source business record that maps to a data field in the target data element, then update the data field of the target data element using data associated with the segment field; and
if a data field of the target data element maps to a data field in the source business record that is not represented by a segment field of the data segment, then initialize the data field of the target data element to an initial data state.

17. The computer system of claim 16 wherein the executable computer program code is further configured to cause the computer component to generate an outgoing delta message representing changes made to a changed business record in the receiving computer system, the outgoing delta message being used to update a target business record (“second target business record”) in the sending computer system, wherein only if a data element in the changed business record corresponds to a data element in the second target business record, then add a data segment to the outgoing delta message which represents the data element in the second target business record.

18. The computer system of claim 17 wherein the executable computer program code is further configured to cause the computer component to:
associate one or more segment fields of the added data segment with data from the changed data element when the computer component determines that the data element in the changed business record has been changed;
add a segment field to the outgoing delta message that represents the data field of the second target business record and filling the segment field with a no-data operator when the computer component determines that the second target business record includes a data field that does not correspond to a data field in the changed business record.

19. A non-transitory computer program product having stored thereon executable program code configured for execution by a computer to cause the computer to perform steps of:
receiving at the receiving computer system, a delta message sent from a sending computer system, the delta message comprising at least one operation code, an identification of a source business record in the sending computer system, and a plurality of data segments representing source data elements of the source business record;
(a) if the source business record does not correspond to any target business records in the receiving computer system, then creating one or more corresponding target business records; and
(b) if the source business record does correspond to one or more target business records in the receiving computer system, then modifying the one or more target business records according to the operation code, including:
if a target data element in the one or more target business records is mapped to a source data element that is not represented by a data segment in the delta message, then deleting the target data element; and
if a target data element in the one or more target business records is mapped to a source data element that is represented by a data segment in the delta message, then:
if a segment field of the data segment represents a data field in the source business record that maps to a data field in the target data element, then updating the data field of the target data element using data associated with the segment field; and
if a data field of the target data element maps to a data field in the source business record that is not represented by a segment field of the data segment, then initializing the data field of the target data element to an initial data state.

20. The computer program product of claim 19 wherein the executable program code is further configured for execution by a computer to cause the computer to perform steps of:
generating an outgoing delta message representing changes made to a changed business record in the receiving computer system, the outgoing delta message being used to update a target business record (“second target business record”) in the sending computer system,
wherein only if a data element in the changed business record corresponds to a data element in the second target business record, then adding a data segment to the outgoing delta message which represents the data element in the second target business record,
wherein if the second target business record includes a data field that does not correspond to a data field in the changed business record, then adding a segment field to the outgoing delta message that represents the data field of the second target business record and filling the segment field with a no-data operator,
wherein if the second target business record includes a data element that does not correspond to a data element in the changed business record, then adding a data segment to the outgoing delta message that represents the data element of the second target business record and filling the data segment with no-data operators.
